(19) United States
(12) Patent Application Publication
(10) Pub. No.: US 2015/0234984 A1
(43) Pub. Date: Aug. 20, 2015

(54) Patient-Centric Portal

(71) Applicant: Zenon Health LLC, New York, NY (US)

(72) Inventors: Wayne J. Singer, Summerville, SC (US); James Tate, Asheville, NC (US); George Steven Blumenthal, New Yoek, NY (US)

(21) Appl. No.: 14/624,075

(22) Filed: Feb. 17, 2015

Related U.S. Application Data
(60) Provisional application No. 61/939,967, filed on Feb. 14, 2014.
(60) Provisional application No. 61/969,414, filed on Mar. 24, 2014.

(51) Int. Cl. G06F 19/00; H04L 29/06; G06Q 10/10

(52) U.S. Cl. CPC G06F 19/322; G06Q 10/1095; H04L 63/0272

(57) ABSTRACT

A system for obtaining substantially all medical information available to a specific patient from satellite portals and adapted to report that information to authorized individuals and satellite portals. The system polls the satellite portals for the medical information and interfaces with the satellite portals without requiring the patient to interface with the API that intervenes upon patient query between the satellite portal and the patient.

### BACKGROUND OF THE INVENTION

The Field of this invention is secure computerized medical records management, and in particular methods and apparatus by which patient records are stored electronically, modified or made available on a computer, smartphone or workstation and accessed by the patient and those having the patient's consent.

### Prior Art

Patient medical record keeping is being computerized. One objective of doing so is to reduce repetitive record keeping where the patient is repeatedly asked to provide the same medical history relevant material. Another objective is to reduce occasions where repetitive testing is done by different institutions. To facilitate organized record keeping by different institutions, health authorities in the United States have encouraged establishing a uniform architecture for the maintenance of medical records. As an example of a response to this encouragement, an HL7 Consolidated Clinical Document Architecture (C-CDA) has been developed as an XML-based markup standard that specifies the encoding and organization of electronic clinical documents suitable for exchange between health treatment centers and/or patients. HL7 is a not-for-profit organization that provides Intellectual Property without charge. The C-CDA provides a base standard with a common architecture, coding, semantic framework, and markup language for the creation of electronic clinical documents. Its structure is object oriented, making use of classes, associations, and inheritance. C-CDA defines building blocks which can be used to contain healthcare data elements that can be captured, stored, accessed, displayed and transmitted electronically for use and reuse in many formats. Sets of C-CDA standardized building blocks can be arranged for different needs. Clinical documents are produced by arranging or constraining the C-CDA elements in different ways. The requirement to use only the C-CDA format to exchange data will create the ability for Continuity of Care to be put into practice.

The United States has enacted HIPAA, the Health Insurance Portability and Accountability Act, which promotes the establishment of national standards for electronic health care transactions. The statue requires all health plans to engage in health care transactions in a standardized way. In particular HIPAA sets security safeguards which must be satisfied by computer systems accessing health related data. Each covered entity is responsible for ensuring that the data within its systems has not been changed or erased in an unauthorized manner. Additionally, HIPAA requires Covered Entities to make sure they are in control of all disclosures of their patient's Protected Health Information. Covered entities must authenticate entities with which they communicate. Authentication consists of corroborating that an entity is who it claims to be.

The United States Department of Health and Human Services is implementing Consolidated-Clinical Document Architecture (C-CDA) for Meaningful Use 2014 Edition, which standardizes Electronic Health Records (EHRs). Before EHRs, vast amounts of patient data was collected by clinicians and medical information, such as vitals, orders, prescriptions, lab notes, discharge summaries, etc., were dictated or recorded by hand. All of this clinical data was stored as paper records (documents) at each point of care. If patient health records were needed to be shared between providers, they usually required manual exchange (e.g. fax, “snail mail”). As a result, the coordination of care between providers was slow and costly and patient outcomes were inconsistent. One result was frequent duplicative healthcare services (e.g. labs imaging).

The expected savings to be achieved through computerization of patient records has encouraged government sponsored programs for medical practitioners and for organizations including clinics and hospitals to use computerized records. Financial incentives have been offered for systems that offer patient access to their medical records. Those incentives are increased substantially where it can be demonstrated that the patients are actually making use of the availability of access to those records. ONC: Standards, Implementation Specifications & Certification Criteria (S&CC) 2014 Edition specifies the capabilities and functions that complete EHRs and EHR Modules must perform electronically in order to be certified under the ONC HIT Certification Program. Meaningful Use (MU2) objectives sets the measurable benchmarks that EPs and EHs/CAHs must meet in adopting and using electronic health record (EHR) technology to qualify for Medicare and Medicaid incentive payments. MU2 sets measurable objectives for Eligible Professionals (EPs) or Eligible Hospitals (EHs)/Critical Access Hospitals (CAHs) to obtain CMS incentives. The MU2 objectives are categorized to reflect Health Outcomes Policy Priorities. These include care coordination and patient engagement, both of which involve using Certified EHR Technology that has C-CDA capabilities. Care coordination requires transition of care and data portability. Transition of care requires that when transitioning a patient to another care setting, the EP or EH/CAH should provide a summary care record. Data portability requires that when a patient transitions from one provider or setting to another, a medication reconciliation should be performed, resulting in an export summary. Patient engagement requires that patients must be able to view and download their own medical information and also be able to transmit that information to a third party. Patient engagement further requires that a system provide clinical summaries for patients for each office visit. Those summaries are required to include specific fields including patient name, sex, date of birth, race, ethnicity, preferred language, care team member(s), medications, medication allergies, care plan, problems, laboratory test(s), laboratory value(s)/result(s), procedures, smoking status, and vital signs. This government sponsorship and organization has resulted in many diverse implementing programs. As a result of the requirements stated above, each provider will offer their patients a portal to access their information. There are no requirements for these portals to be able to communicate. Therefore a patient can have multiple portals that have their information in digital silos. As such, such “Satellite Portals”, absent the functionality of the invention, would require patients and their authorized users to access the stored information in a tedious, one-by-one approach, leaving the potential for missed information or disorganized collection that could interfere with continuity of care.

Patients typically have medical records residing at several different institutions, each of which has made its own determination how to deal with security issues and how to make those records available. Typically, the institutions each have their records available through an Application Program Interface (API) which differs from institution to institution. Attempts have been made to collect and organize the records for particular patients by mastering the details of each of those interfaces. What is lacking is a more efficient system for centralizing the records for a particular patient so that they may be obtained by the patient and those whom the patient authorizes to have access.

Also lacking is a system that is patient-centric, i.e. that makes available to a patient or to a health provider authorized by the patient access to specific information relevant to that particular patient. In particular, what is lacking is a system that simplifies for the patient the act of getting access to its information that may be located at different institutions, each of which has its own interface for accessing the information. What is also lacking is a system that is self-executing in the sense that the system continually seeks out and pulls in relevant patient data keeping itself up to date rather than relying upon diverse local systems to push the data to the system.

The examples of the art related to this invention and the limitations of that art are illustrative and not exhaustive. Other limitations will be apparent to those skilled in the relevant art upon reading the specification and studying its drawings.

### BRIEF DESCRIPTION OF THE INVENTION

The following embodiments of the invention are descriptive of ways in which the invention may be implemented and are not intended to be limiting in scope. Some of the embodiments are directed to solving the limitations of the problems identified as background; others are directed to different improvements.

This invention concerns computerized medical records management, and in particular, cloud-based software by which electronically stored patient records and other data can be aggregated from multiple sources by a single user, allowing a patient (or authorized representative of the patient) to access, and share, in a secure fashion, with other care-givers (such as family members or paid professionals) to whom they grant access, their medical history and related data. The related data may include information available to the user by aggregating content from third-party databases related to medications, pricing, insurance information and general health information (either in real-time or as a batch). The system automatically, at regular, pre-determined and configurable intervals (or upon manual instruction), accesses the health records stored typically in “patient portals” or other similar repositories online by individual healthcare and similar providers (i.e., the Satellite Portals), and aggregates those records and related data in a single-login environment located in servers or other facilities constituting a cloud accessible from a user's browser. Real-time notification is provided to appropriate authorized users of the presence of new information. The system's chief objective in having a single point of access that can be shared, is to facilitate the continuity of care of such patients for prevention and or chronic disease management. Attendant benefits of this are:
Patients have near-real-time access to all of their medical information eliminating risks to the patient of not having all information and reducing the need for patients proactively to reach out and seek records from multiple providers.
Office efficiency is improved for healthcare providers by eliminating or greatly reducing the administrative burdens of manually providing information to patients and the need to constantly forward duplicative information to multiple parties such as other doctors and caregivers. Additionally, the reduced number of calls to an office asking when information will be available.
Through the efficiencies created by the system, the likelihood of duplicative, unnecessary or otherwise preventable medical care is greatly reduced resulting in benefits to the healthcare insurance providers as well as the patients.
Patients need only remember a single login ID and password once each portal's login information has been stored in the system (using industry standard encryption).

Further enhancing the functionality, the system provides real-time alerts notifying the user of updated information as the system collects such data, which alerts can be assigned by the patient to whichever recipients the patient chooses. Given the proliferation of portable and wearable web-enabled devices, this makes it possible for users constantly to be up-to-date on medical data.

The system also takes advantage of the recently implemented incentives passed by the federal government under the HITECH Act, enacted under the ARRA Act of 2009, that incentivize healthcare providers to utilize electronic health records, and in turn provide patients access to such records through ‘patient portals’. When a patient uses the system, healthcare providers will benefit because the system's polling of each repository or portal will, in many cases, help the provider meet minimum “meaningful use” requirements to qualify for the incentives, which currently require at least 5% of patients actually use the portals in certain ways to qualify. Healthcare providers will also benefit under other various incentive programs that require certain measures of efficiency enhanced by the system.

To access certain related data from third parties each user will be able to enter their own insurance information into the system as part of their user profile. Using the HIPAA Eligibility Transaction System (NETS) the system can then import all of the relevant features of that patient's health insurance (e.g., real-time eligibility, deductibles, in-or-out of network providers, amount of copays and co-insurance and all other relevant data).

This invention provides a unique configurable CODEC based inquiry and submission process for utilization and management of healthcare related information. It is used to implement methods to access, retrieve, aggregate, share, and distribute codified health care, financial, insurance, demographic, and data elements in an HIPAA secure environment.

The invention enables a unique application which is a Patient-Centric Portal/process and subsequent functionality where a patient's healthcare and related data will securely reside online. This Portal serves to be the centralized repository for all of the patient's healthcare related information: demographics, insurance, pharmacies, emergency contact (s), archived historical laboratory, imaging studies, and all inclusive medical histories. Patient data will be accumulated and made available by automated and/or manual acquisition from multiple sources (hospitals, clinics, pharmacies, physician offices, insurance entities, and other points of healthcare services). The patient and authorized representatives will be able to view, download, and securely transmit data residing in the portal always under security control so that the authorization for access to specific patient data is subject to determinations by both the healthcare provider and the patient.

The patient will have the ability to differentiate the specific source of each item of the imported data. This centralized “primary” Portal data, that the invention has aggregated, can be used to generate patient-specific education and clinical decision alerts. These triggered alerts can be automatically sent to a patient and or their representatives on a real-time basis, using e-mail, text or other digital information services. Information can be printed, downloaded and exported from the Portal. Secure messaging (Direct Protocol compliant) functionality allows messages to be securely transmitted and received by the Portal to each individual satellite portal. A dashboard will centralize all messaging functionality. A calendar will centralize all calendar information from the satellite portals as well as allow manual addition. The Portal will contain an updatable list of the patient's physicians, pharmacies and hospitals complete with their phone numbers hours of operation and directions to their location.

### BRIEF DESCRIPTION OF THE DRAWINGS

FIG. 1 depicts a Medical Information System with which the portal system operates.

FIG. 2 depicts an embodiment of the Patient-Centric Portal System of the present invention.

FIG. 3 a Patient-Centric Portal embodiment of the present invention.

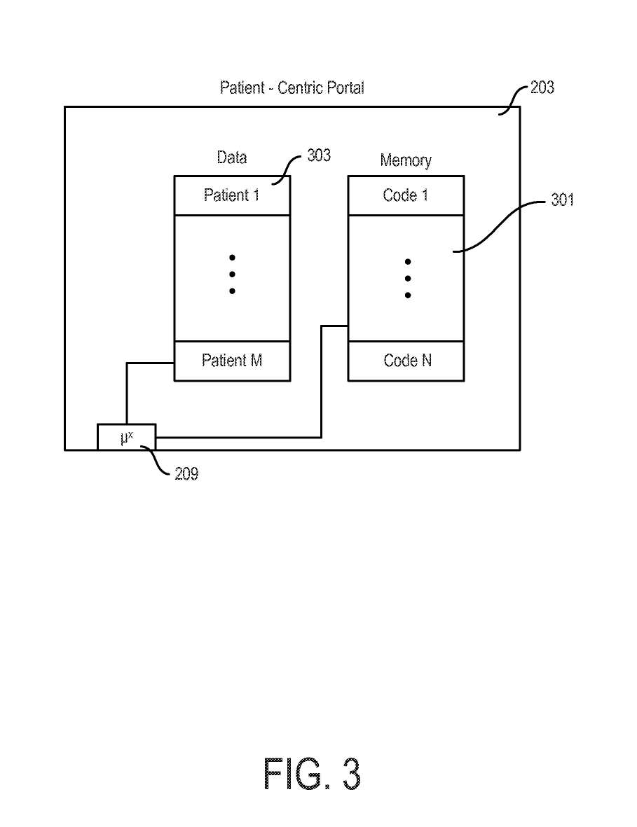

FIG. 4 depicts the stages of operation of the data aggregation function of the Patient-Centric Portal.

FIG. 5 depicts a home screen of a preferred embodiment of the invention.

FIG. 6 depicts a screen reached by having selected alerts.

FIG. 7 depicts a centralized patient calendar function of a preferred embodiment of the invention.

FIG. 8 depicts an insurance coverage function of a preferred embodiment of the invention.

FIG. 9 depicts a secure communication function of a preferred embodiment of the invention.

FIG. 10 depicts a graphic depiction of trends in the data of a preferred embodiment of the invention.

FIG. 11 depicts linking to patient's problems, medication and/or health requirements of a preferred embodiment of the invention.

FIG. 12 depicts graphic information on income going to medical health of a preferred embodiment of the invention.

### DETAILED DESCRIPTION OF EMBODIMENTS

The present invention provides a computerized medical records system comprising software apparatus and methods that are used by clinicians and patients. The system is installed in a medical facility, for example a hospital, nursing home, clinic, or other medical enterprise. The system includes distributed workstations or client computers and a centralized database server to house a database for patient information. The workstations could be handheld computers or general purpose computers having a processor, and one or more memories both for storage of information and containing the operational software. That software provides an interactive, client-server based patient portal system executed by the processor in the workstations. The database may be centralized or implemented as a distributed database.

### Data Inclusion:

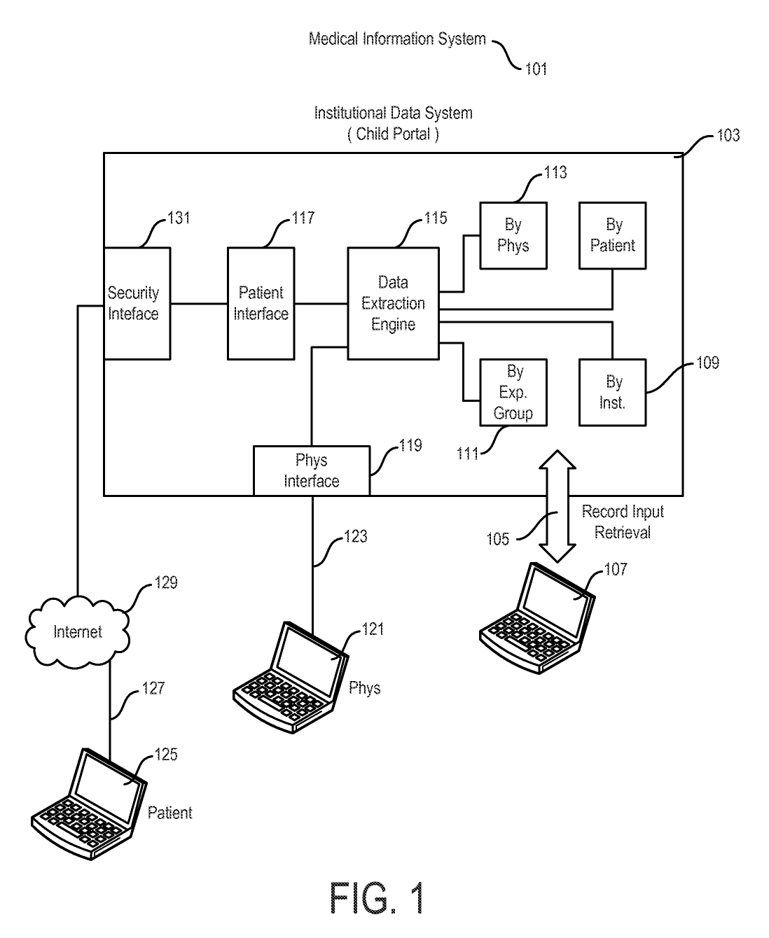

FIG. 1 depicts a Medical Information System 101 comprising one or more Institutional Data Systems 103, also termed a Satellite Portal. Each Institutional Data System 103 is designed to receive medical information over a network 105 from physicians, medical practitioners or laboratories from Record Input and Retrieval computer equipment 107. The network 105 may be a wired LAN or WLAN or with proper security may be established by remote communication. Acceptable communication protocols may include WCDMA or GSM communication systems, and the computer equipment 107 may be a terminal or tablet, smart phone or a PDA. The Institutional Data System 103 has one or more databases of medical information that may be centralized in a singular database with multiple fields or divided into separate databases according to how the information is received or expected to be accessed. For example, the database of information may be separately maintained 109 according to the institution or department of an institution that created all or a portion of a particular data record. The information may be separately maintained 111 by the expert group, for example a laboratory, that created all or a portion of a particular data record. Such a laboratory could be a radiology group or a screening laboratory. The information may be separately maintained 113 for each physician or practitioner that is permitted to create records in the Institutional Data System 103.

Within the Institutional Data System 103 there is a Data Extraction Engine 115 which can respond to requests for particular types of records, by extracting responsive records from the informational databases 103, 109, 111, 113. The Data Extraction Engine 115 is provided with an interface to those requesting information. The interface may be comprised of separate interfaces generally termed a Patient Interface 117 and a Physician Interface 119, although the two interfaces may be combined into a single structure able to distinguish whether the information being sought through the interface is coming from a patient or from another authorized requesting source. Physicians' computers 121 may access information over the Physicians Interface 119 over a network 123, which may be any of the types of network previously mentioned for inputting information. The computer devices 107, 121 may in fact be the same device.

Patients using computer devices 125 may seek access to information from the Institutional Data System 103 over a patent access network 125 that may include an Internet 129 portion. The patient access network may have to pass a security interface 131 before gaining access to the Patient Interface 117. In this system, there may be data that is entered and available to physicians but not yet released to patients for them to view or download. Such information may be laboratory results that require analysis and explanation to the patient before being made available to the patient. In this manner, physicians may provide the patient with a prognosis before releasing data that could be upsetting to an uninformed patient.

The result of such a system is to provide and Institutional Data System that may contain all the relevant information about a particular patient, while holding back from the patient certain of its information. The present invention is concerned with the information that is available to the patient, and in its preferred embodiment only that information.

When the patient's health data includes medications, procedures and other relevant items pertaining to healthcare provider visits, the system will allow the patient access, either through data collected by the System or data polled from third-party databases, to see the pricing and availability of the medications, procedures, diagnostic images, lab tests and other events for which a patient would incur a cost. A map will display to the patient where they can purchase the foregoing cost-items near their location, or within a designated geographic area of their choice. The cost data will be presented both for retail and generic versions of medications. In each case, the system will calculate the net cost to the patient after applying their particular insurance policy's reimbursement or coverage of such cost, and display that amount. This will enable unprecedented price transparency to patients, a long-stated goal of many healthcare policy experts. Insurance data will be polled from a secure SOAP or sMIME IP address supported by the HETS.

Insurance information will also be presented in a manner to allow the patient to track relevant cost information including their deductibles, showing how much the total individual and family deductibles are for their policy, and how much has been used in each category as of the time the user reviews the data. Additionally, they will see all items (medications, procedures, DME) that require prior authorization to avoid unexpected out-of-pocket costs.

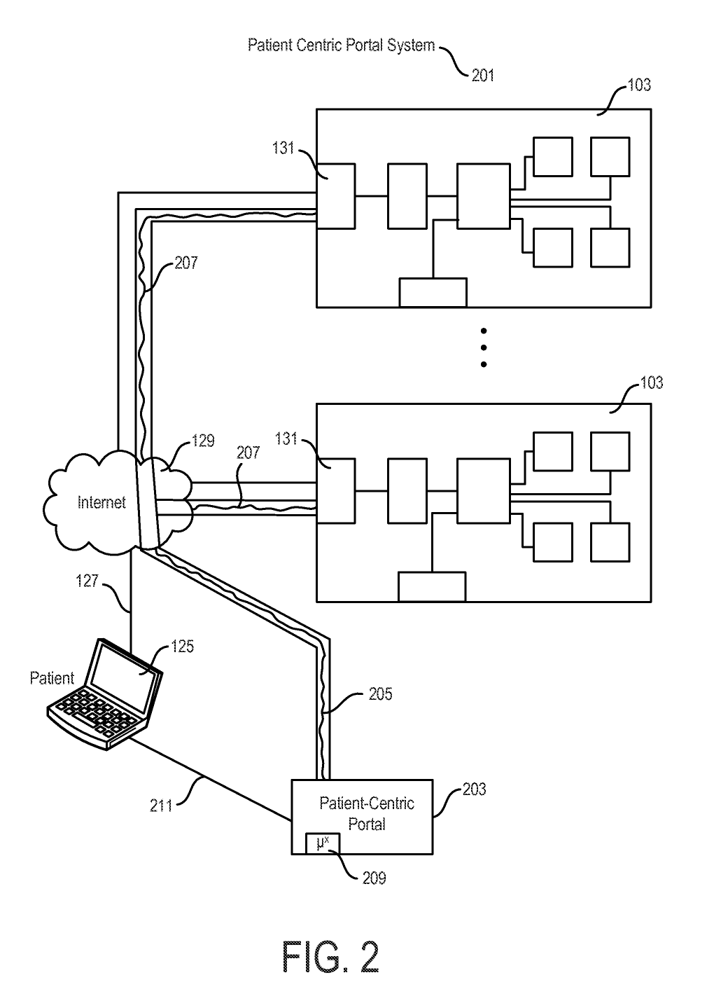

FIG. 2 depicts a Patient-Centric Portal System 201, comprising with multiple satellite portals 103 maintained by different medical providers. Patients may continue to extract data from the satellite portals 103 in the manner previously described with respect to FIG. 1, which is by direct access over a network that may comprise the Internet.

A Patient Centric Portal 203 resides on computer hardware, which may comprise servers, server networks, or emulations of servers or server networks, or any other form of memory that can be accessed via a port on the Patient Centric Portal. The Patient Centric Portal 203 maintains access to each of the interfaces 131 accessible to patients, via tunnels 205, 207 over the Internet. The tunnels 205, 207 permit secure communication between the Patient-Centric Portal 203 and the Institutional Data Systems 103, with the ability to access the same information as may be accessed on the patient's computer 125. The tunnels 205, 207 are maintained by encrypting and subsequently decrypting the information passing to and from the Patient-Centric Portal 203 and the Satellite Portals 103. The encrypting/decrypting function is established by a codec maintained by a processor 209, which is a component of the Patient-Centric Portal 203. Via a portion 205 of the tunnel, the patient and the Patient Centric Portal 203 may communicate directly to exchange information that the Patient Centric Portal has derived from the Satellite Portals. In this manner, the Patient-Centric Portal may act as an agent for the patient and provide in a centralized format the information derived from a plurality of Satellite Portals 103. In addition, the Patient's computer 125 may communicate directly with the Patient-Centric Portal 203 over a network connection 211 established for that purpose. It is understood that as used here the concept of tunneling is meant in a broad sense that may include establishment of a virtual private network to establish the secured connections described herein.

Data may be accessed and retrieved from the satellite portals 103 by the Patient-Centric Portal 203 on demand and by automatic time configurable polling. The polling is achieved by the various satellite portals having software to recognize the patient-centric portal and permitting it entry into the internal data base residing on the satellite portal. Once recognized, the patient-centric portal is enabled to identify information that it is permitted to copy onto the patient-centric portal. In this manner the patient is not required to interact directly with any API that confronts others seeking information from the satellite portal's internal database.

Data for the patient-centric portal may be by direct input via the import of files (DICOM, CODA, Outlook calendar files, etc.), by input via manual entry, input via biometric devices, or input via scanned documents (PDF and other image formats).

The systems will provide on demand patient specific educational resources based on system patient data. As patient data populates the screen, items including conditions, medications, lab results and other particular pieces of data will contain links to articles and information for the user related to the particular item. This information will be displayed within a frame on the system, allowing the patient to stay on the patient-centric portal without having to exit the website. Links to some of the most well-known healthcare information websites will be provided (e.g., WebMD). Additionally, there is a search function in the patient-centric portal that allows a patient to enter a search that will display results within a frame on the system's website. A customization feature will allow the patient to save links to their own favorite resources.

The managers of the system will also regularly add relevant articles and other up-to-date current information about various healthcare issues, and present that information, tailored to be relevant to the particular user, as available for the user to read within the system.

### Codecs

The Patient-Centric Portal 203 polls each satellite portal using a codec designed for each unique portal. Each codec allows the system to access, through the “front door” user interface 131, each unique patient portal. Each codec is customized to each portal so that the system can mimic the actions of a live user, using that particular system, navigating through to the standardized format data contained on the system that represents the sought after medical information, and retrieving it. Because approximately 80% of today's users are accessing one of about 15 portals that are used by major companies that provide EHR services, the system provides codecs for these portals so that they are supported at launch. As additional requests for new portals are made, within a relatively short turnaround time, the system is adapted to provide the necessary unique codec for each such system, creating an ever-growing list of codecs and corresponding supported systems. Users are notified as soon as their account is ready, when the applicable codec is added. Turnaround time is intended to be within 5 business days.

The Patient-Centric Portal 203 comprises a memory 301 in which are stored the various codecs adapted for use with the different Satellite Portals 103. The patient data retrieved from the various Satellite Portals is stored in a memory 303, which may be the same as Memory 301, or separate therefrom. Both memories are under the control of software stored in a memory that directs the processor 209. For security, the patient data may be kept in an encrypted form. Also, as part of the patient data is the login information that the patient uses to directly login to the satellite portals. The Patient-Centric Portal is adapted to crawl from Satellite-portal to satellite-portal and pull in patient data to its memory 303. To avoid redundancy, each record pulled from the satellite portals is associated with a date and time, so that the data contained in memory 303 may be efficiently updated.

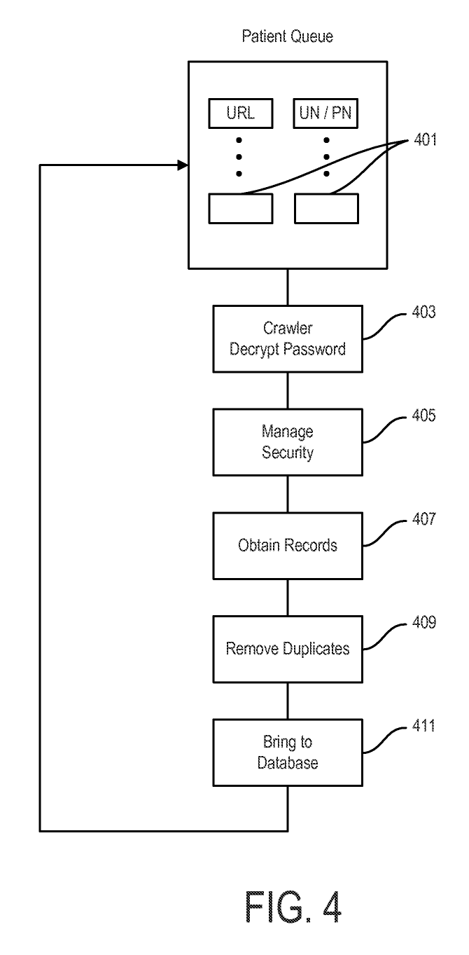

FIG. 4 depicts the stages of operation of the data aggregation function of the Patient-Centric Portal. The system comprises a patient queue in which is contained the URL for each Institutional Data System. The operation begins by selecting a next 401 URL and the associated patient User Name and Password in the queue. The crawler software causes 403 the system to access the next satellite portal. Where necessary the password information is decrypted. The codec appropriate to the satellite portal is selected by the crawler and security at the satellite portal is provided with authenticating information. In some instances, the satellite portal is guarded by an interface intended to defeat unauthorized web-crawlers by requiring the reduction to text of images that are hard to discern. By a combination of software adapted to reduce images to text, the security is managed 405. The records relevant to the particular patient and made available for access by the patient are obtained 407, duplicates are removed 409 and the patient data is brought 411 into the Patient-Centric Portal's database.

The Patient-Centric Portal is adapted to perform multiple functions with the data obtained from the satellite portals in addition to merely making the data available to the patient in a centralized location. Those functions comprise additional features of preferred embodiments of the invention.

### Types of Access

The portal system provides In Case of Emergency (ICE) access, patient access and authorized representation access (with read only or read/write capabilities). In each instance, access to specific data is controlled by tags indicating which satellite portals may have access to the patient-centric portal data. In that manner, the patient or a health provider can determine how widely its information is shared.

The information relating to a plurality of patients may also be displayed. The system allows Friend and Family Access, for example by providing a dashboard view for multiple patients, and Case Manger Access providing a dashboard view of numerous patients with ability to apply specific continuity of care protocols based on one or more data elements (problem list, medication list, medication allergy list, lab test results, and third party payers).

### Functionality

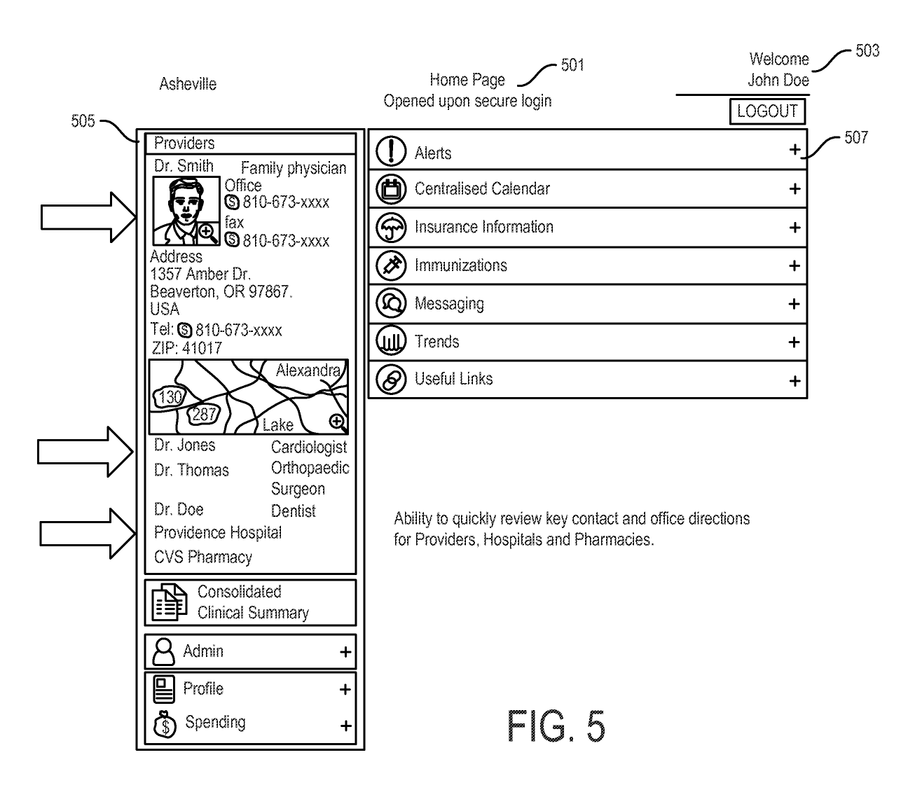

FIG. 5 depicts a home screen 501 displayed upon patient access via secured login to the Patient-Centric Portal System. The screen identifies the patient 503 and provides access to information on the various information providers 505 and provides office direction for providers, hospitals and pharmacies. In addition there are links for different major functions 507 of the system. These include Alerts, a Centralized Calendar, Insurance Information, Immunizations, Trends and other Links.

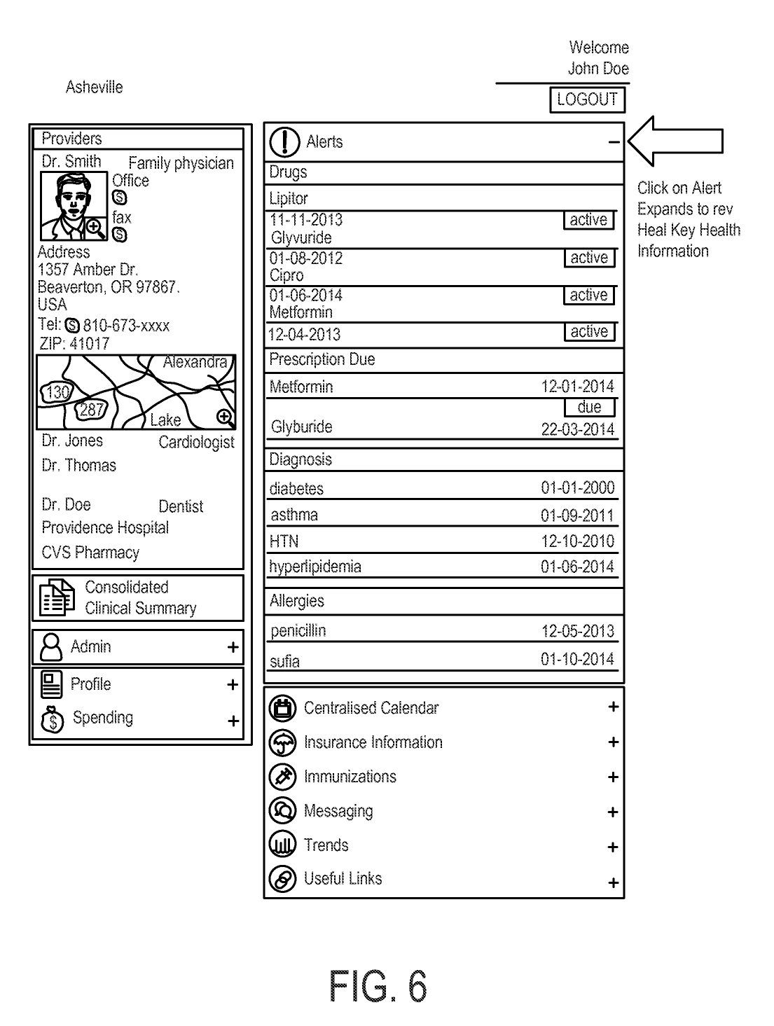

FIG. 6 depicts a screen reached by having selected alerts, to reveal key health information including prescriptions due, diagnoses and allergies.

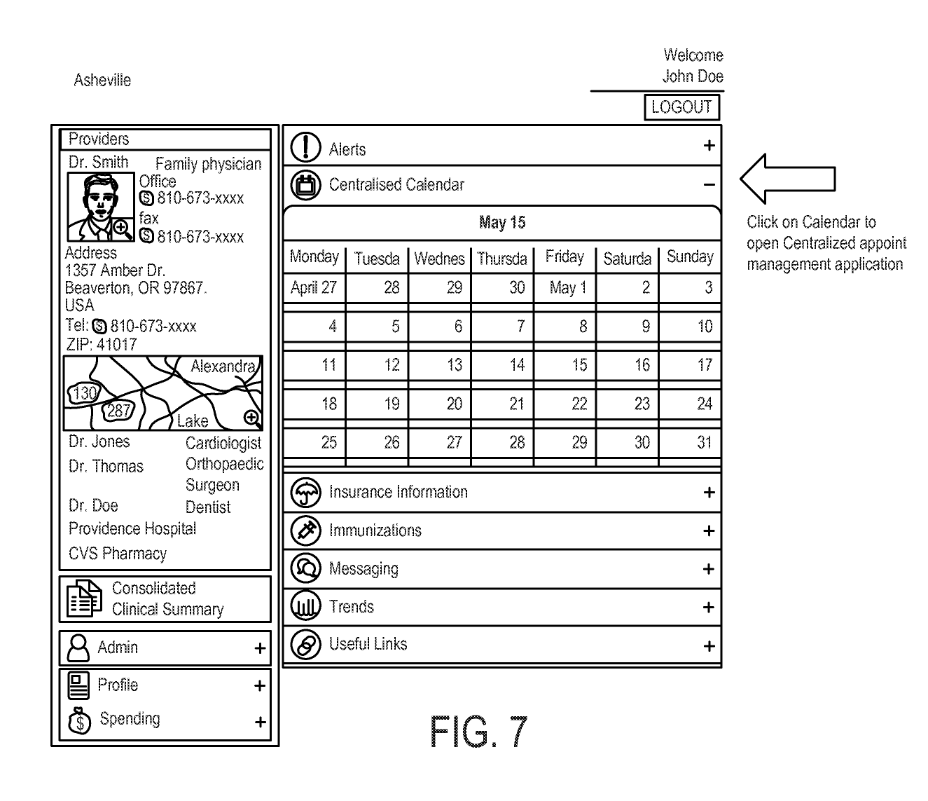

As depicted in FIG. 7, the patient-centric portal system has the ability to support a centralized patient calendar (to maintain appointment lists, medication refills and transportation requirements). The calendar will centralize all calendar information from the satellite portals as well as allow manual addition. The calendar will provide the incorporation of configurable reminders that can be sent to the patient, and/or their authorized representative.

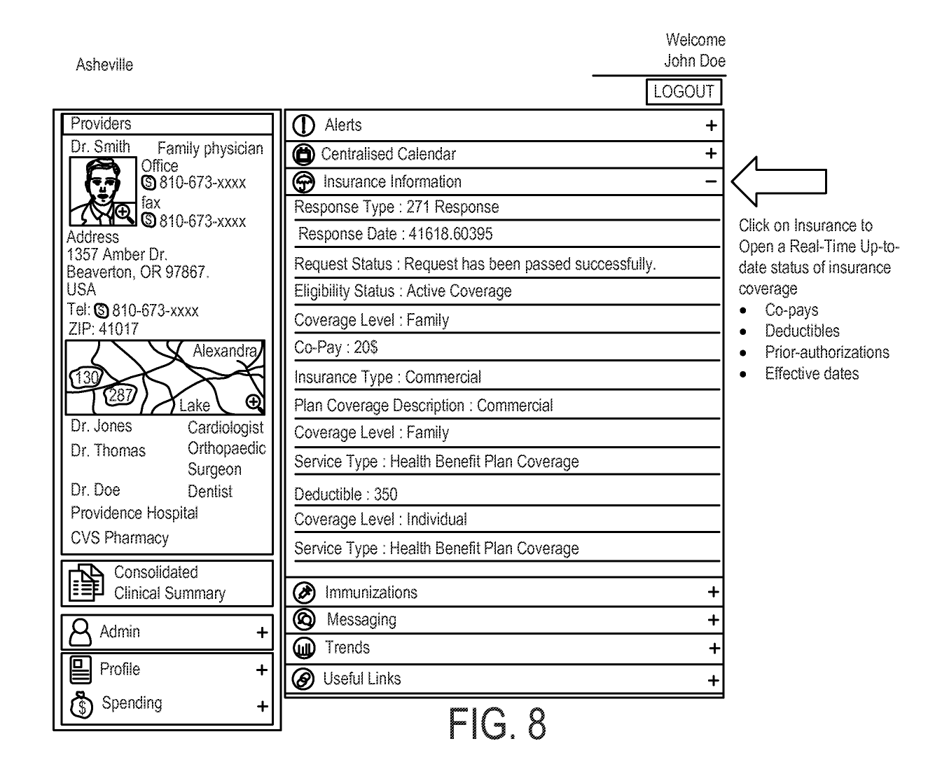

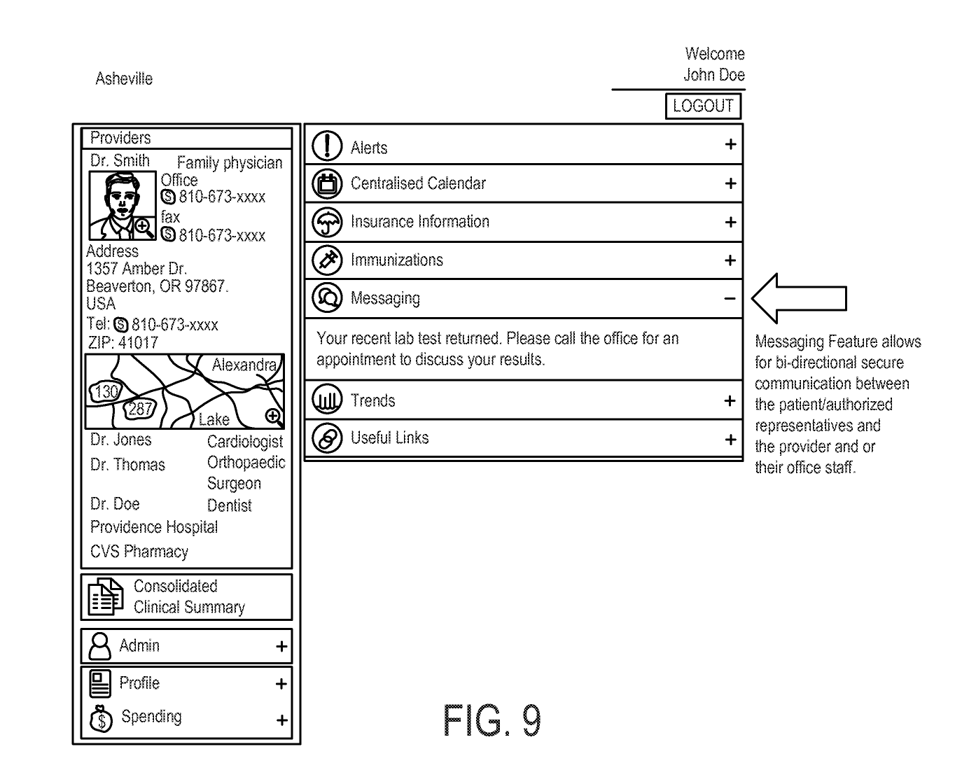

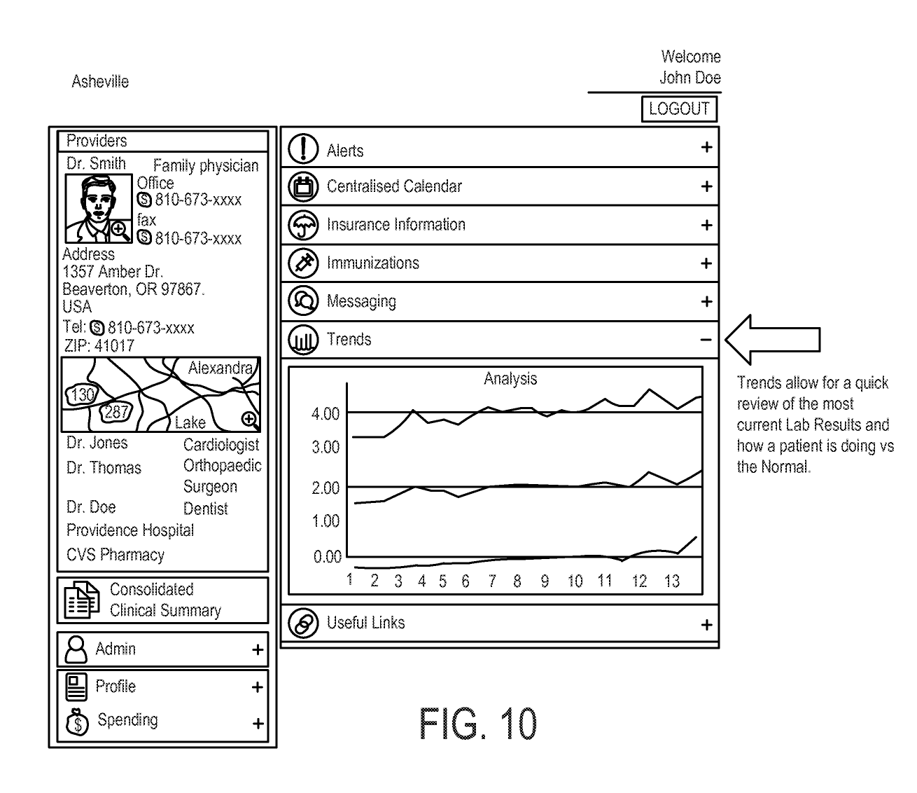

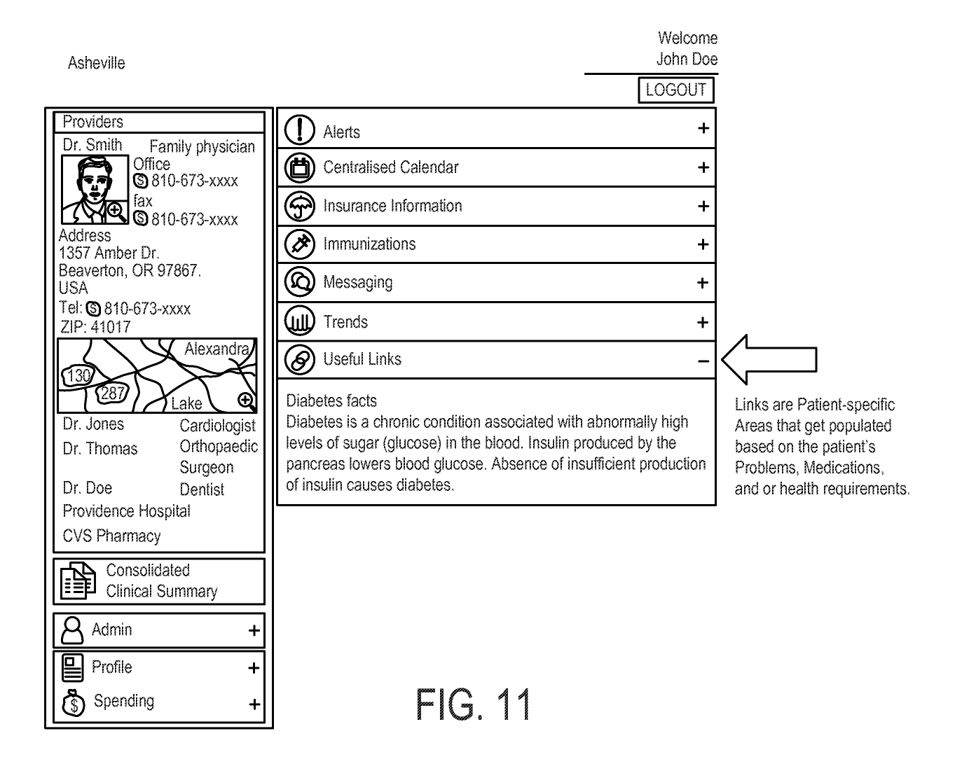

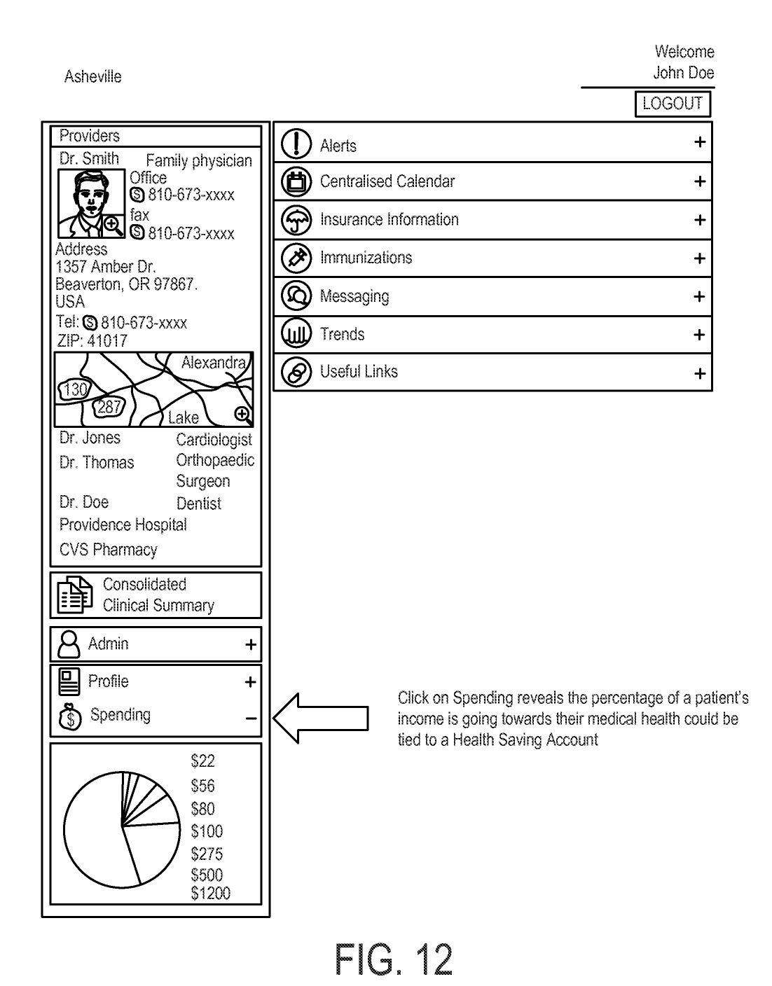

As depicted in FIG. 8, the system provides real-time up-to-date status of insurance coverage, including co-pays, deductible, prior-authorizations and effective dates. FIG. 9 provides a screen from which the system allows bi-direction secure communication between the patient/authorized representatives and a provider and/or their office staff. FIG. 10 provides a screen with graphic depiction of trends for the quick review of the most current lab results and a comparison with normal values. FIG. 11 depicts a screen that provides links to areas that get populated based on the patient's problems, medications, and/or health requirements. FIG. 12 provides a screen with graphic information on the percentage of patient income going towards their medical health and could be tied to a Health Savings Account.

The patient-centric portal also has several functions providing the following ability:
Ability to input “notes” in both structured and non-structured format and search those notes.
Ability to proceed directly to a “satellite” portal from the Portal without additional authorization. The ability to differentiate between patient-entered information and provider-entered information.
Track/audit applicable actions (manual and automatic) and provide reporting capability to meet current and future patient engagement and related ONC meaningful use measures. Ability to send the necessary information that confirms activity on behalf of the patient to satisfy the provider's meaningful use requirements relative to the CMS EHR Incentive Program for Stages 1, 2, and 3
Ability to configure the user interface including level of data views, permissions granted to authorized representatives, and usability (Senior Mode, etc.)
Ability to “hide” certain information based on the permission level granted.
Alerts generated from the “satellite” portal can be pushed to the patient's (or authorized representative) personal email, IM, and or mobile device in addition to alerts that are generated at the “core” Portal. All sources and time/date of alerts are identified and recorded.
Ability to generate real-time (24/7/365) and on demand drug-drug and drug-allergy alerts. Ability to configure clinical decision support rules and send alerts on a real-time basis to identified recipients. Automatic checking is performed upon addition of any new relevant clinical data.
Ability to generate, view, download and transmit a reconciled clinical summary (from multiple clinical summaries) in C-CDA, Blue Button, PDF, or ASCII text formats.
Ability to configure the automatic sending of secure messages containing clinical data and/or system generated alerts received from one health care provider to one or more additional members of the patient's healthcare team.
Ability to generate search results via: the HL-7 InfoButton standard, a general search capability, and Google Alerts.
Ability to send and receive secure messages and produce related meaningful use audits and reports.
The ability to automatically present the patient's insurance eligibility in real-time including deductibles, co-pays, formularies. Ability to view/manage their Health Savings Account. The ability to monitor healthcare related spending (managing deductibles and/or co-pays throughout the year). This will include alerts that signify when deductibles have been met.
Ability to present a reference guide to current medications (with pill pictures).
Ability to maintain directory and contact information (including hyperlinks) for providers, care team members, home health care companies, pharmacies, and related entities.
Ability to trigger reminders to take appropriate medication.
Auto population of pharmacies, durable medical equipment supplies, hospitals, diagnostic facilities in the patient's geographic area (based on patient zip code on other location identifier, IP address, etc. Provided in list and/or map format.
Ability to provide cost information for treatment/diagnostic procedures, medical supplies, and patient medication based on patient zip code on other location identifier (IP address, etc.).
Ability to modify patient location manually to generate customized list and/or maps of healthcare related providers, suppliers, pharmacies, or resources
Ability to display trending data representation for lab results, exercise goals, nutritional intakes, and vital signs.
Ability to incorporate real-time audio/video feed to 2 or more nodes to be the access point for an on-line clinical encounter with providers, authorized representatives, and case managers. Portable Device Data

In addition to the data aggregated from Satellite Portals, the System will allow users to link to various devices that now are capable of transmitting real-time data in the home, either via Bluetooth, Wi-Fi or as yet to be developed near-field technologies. Examples of this are glucometers that transmit blood-sugar levels after a test, and scales monitoring patient weight. The system will collect this data and present it in an ongoing, chart format for the patient to see their results. The System will trigger an alert when trends or results would, under circumstances either set by the user or polled from third-party sources, require special attention. This alert can be set to notify the healthcare professional as well as the patient.

Pharmaceutical Information

In addition to the cost-related data, the system will allow the user to see an actual image of the medication they are taking, obtained from a third-party database. This medication identifier can be used in combination with a medication reminder application (displayed on smart phones and or television monitors) to assist the patient choose the correct medication when there are many to choose. The system will also provide the user with any drug to drug and or drug to allergy interaction information, based upon the medications the particular user is taking. Standard, federally mandated patient disclosures about the medications will be presented, along with summary information available through third-party websites which will display within a frame on the system. An additional feature will be to allow the user to elect to hear a synthesized or pre-recorded voice to read the key patient data for medications (e.g., side effects, contraindications, etc.), in a manner similar to what is often recited in television and radio advertisements for medications.

While a number of examples and embodiments have been described, those of skill in the art will recognize certain modifications, additions or combinations that may be made to the specifics without deviating from the present inventive concepts. It is therefore intended that the invention be what is described in the following appended claims.

We claim:

1. A medical information system comprising
an institutional data system (“child portal”) having a physical interface and a security interface,
a patient portal networked to said institutional data system over an Internet connection,
a physician portal networked to the physical interface of said institutional data system, and
a record input and retrieval terminal networked to the institutional data system for record input or retrieval,
wherein said institutional data system further comprises
a data extraction engine implemented in a codec for encrypting and decrypting all patient information passed between portals in communication with said physical interface and in communication with a patient interface with said security interface wherein said data extraction engine is adapted to receive information input by physicians patient's institutions and loboratory groups.

2. A patient centric portal system comprising a plurality of institutional data systems networked to a patient centric portal by a virtual private network said institutional data systems networked over the Internet to a patient portal, said patient portal in communication with the patient centric portal.

3. The patient centric portal of claim 2 comprising a microprocessor linked to a memory program to implement one or more codecs and a database providing storage of information from one or more patients.

4. The medical information system of claim 1 further comprising software implementing the display of a homepage opened upon secure login providing the ability to review contact and office directions for providers, hospitals and pharmacies.

5. The medical information system of claim 4 providing an alert that expands to display key health information

6. The medical information system of claim 1 providing a calendar for centralized appointment management.

7. The medical information system of claim 1 providing real-time up-to-date status of insurance coverage including co-pays and deductibles, prior authorizations and effective dates.

8. The medical information system of claim 1 providing a messaging feature allowing for bidirectional secure communication between the patient or authorized representatives and the provider or their office staff.

9. The medical information system of claim 1 providing review of most current lab results.

10. The medical information system of claim 1 providing patient specific areas populated based on a patient's problems, medications, and/or health requirements.

11. The medical information system of claim 1 further providing spending information concerning the percentage of the patient's income going towards the medical health.
